(19) United States
(12) Patent Application Publication
(10) Pub. No.: US 2020/0018429 A1
(43) Pub. Date: Jan. 16, 2020

(54) IN-LINE CONNECTOR LOCKING SYSTEM

(71) Applicant: Jerry Jackson, Winter Garden, FL (US)

(72) Inventor: Jerry Jackson, Winter Garden, FL (US)

(21) Appl. No.: 16/510,822

(22) Filed: Jul. 12, 2019

Related U.S. Application Data
(60) Provisional application No. 62/697,794, filed on Jul. 13, 2018.

(51) Int. Cl. F16L 3/22; F16L 39/00; F16L 3/06; F16L 3/01

(52) U.S. Cl. CPC F16L 3/222; F16L 3/01; F16L 3/06; F16L 39/005

(57) ABSTRACT

An in-line connector locking system includes an elongated, generally hollow first sleeve member having an open first end, a closed second end and a plurality of threaded elements positioned along the outside surface. The system also includes an elongated, generally hollow second sleeve member having an open first end, a closed second end and a plurality of complementary threaded elements located along the length of the hollow interior surface. The first and second sleeve members are removably secured together via a twisting motion and encompass an in-line connector. A mounting clip is provided for securing the first sleeve, second sleeve and in-line connector to an external structure.

### CROSS-REFERENCE TO RELATED APPLICATIONS

This application claims the benefit of U.S. Application Ser. No. 62/697,794 filed on Jul. 13, 2018, the contents of which are incorporated herein by reference.

### TECHNICAL FIELD

The present invention relates generally to cable management, and more particularly to a locking system for in-line type connectors.

### BACKGROUND

The statements in this section merely provide background information related to the present disclosure and may not constitute prior art.

There are many different types of cables and cable connection fittings for use with different types of electrical devices. For example, one of the most commonly utilized type of cable connection fittings for Direct Current (DC) devices is known as a barrel connector. These connectors are inexpensive to manufacture and include a cord that terminates into a small body section having a single male plug that engages a single female socket of similar construction in a linear orientation.

Although these types of connectors work fine when the connection is maintained, one common problem is the ease with which these connectors become separated. Moreover, due to the low manufacturing cost, the connectors are quite fragile and prone to breaking if a force is applied to either cable/connector in a direction other than purely linear.

Accordingly, it would be beneficial to provide a protection and locking mechanism that can be secured to the male and female components of an in-line connector in order to prevent inadvertent separation and/or damage to the same.

### SUMMARY OF THE INVENTION

The present invention is directed to an in-line connector locking system. One embodiment of the present invention can include an elongated, generally hollow first sleeve member having an open first end, a closed second end and a plurality of threaded elements positioned along the outside surface. The invention can also include an elongated, generally hollow second sleeve member having an open first end, a closed second end and a plurality of complementary threaded elements located along the length of the hollow interior surface.

Each of the first and second sleeve members include dimensions suitable for receiving an in-line connector such as a barrel plug or an electrical plug and socket. The first and second sleeve members can be secured together via a twisting motion whereby the first sleeve member is removably positioned within the second sleeve member, and the in-line connector is secured within the center of the first sleeve member.

In one embodiment, a mounting clip having a curvilinear top surface and a pair of resilient arms can be removably secured to the first and second sleeve members. The mounting clip can include apertures for receiving hardware for securement to an external structure.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a perspective view of an in-line connector locking system, that is useful for understanding the inventive concepts disclosed herein.

FIG. 2A is a side view of a first sleeve member of the in-line connector locking system, in accordance with one embodiment of the invention.

FIG. 2B is a perspective view of a first sleeve member of the in-line connector locking system, in accordance with one embodiment of the invention.

FIG. 3A is a side view of a second sleeve member of the in-line connector locking system, in accordance with one embodiment of the invention.

FIG. 3B is a perspective view of a second sleeve member of the in-line connector locking system, in accordance with one embodiment of the invention.

FIG. 4A is a side view of the in-line connector locking system in operation, in accordance with one embodiment of the invention.

FIG. 4B is another side view of the in-line connector locking system in operation, in accordance with one embodiment of the invention.

FIG. 4C is another side view of the in-line connector locking system in operation, in accordance with one embodiment of the invention.

FIG. 4D is another side view of the in-line connector locking system in operation, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

As described herein, an “in-line connector” can include two components that are removably secured together in a linear manner, regardless of the overall shape, size, voltage and/or intended purpose of the same. Several nonlimiting examples include but are not limited to DC barrel type plug and socket connectors, AC connectors such as a plug and socket, wire to wire connectors, and/or DIN connectors, for example.

As described herein, the term “complementary shape,” and “complementary dimension,” shall be used to describe a shape and size of a component that is identical to, or substantially identical to the shape and size of another identified component within a tolerance such as, for example, manufacturing tolerances, measurement tolerances or the like.

As described herein, the term “removably secured” and derivatives thereof shall be used to describe a situation wherein two or more objects are joined together in a non-permanent manner so as to allow the same objects to be repeatedly joined and separated.

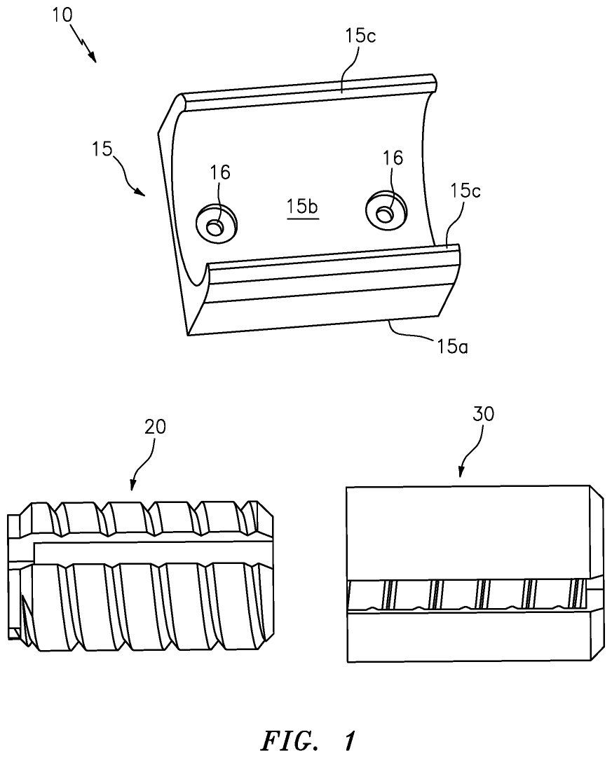

FIGS. 1-4D illustrate one embodiment of a barrel connector locking system 10 that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

As shown in FIG. 1, the system 10 can include, essentially, a mounting clip 15 for engagement by a first sleeve device 20, and a second sleeve device 30.

In one embodiment, the mounting clip 15 can include an elongated, generally U-shaped member having a flat bottom end 15a a curvilinear top end 15b and a pair of resilient arms 15c extending upward therefrom. The curvilinear top end preferably includes a cross sectional shape and dimension that is complementary to the cross-sectional shape and dimension of the second sleeve member.

Likewise, the distance between the arms 15b is preferably complementary to the outside dimensions of the second sleeve 30. The sleeve clip can be constructed from any number of resilient materials so as to allow the side walls to expand and contract. In one embodiment, the bottom wall of the sleeve clip can include a pair of apertures 16 apertures through which mounting hardware such as screws, for example, can be placed. Such a feature allows a user to mount the sleeve clip to a wall, desk or other such structure and to maintain the cables located within the sleeves in a fixed position.

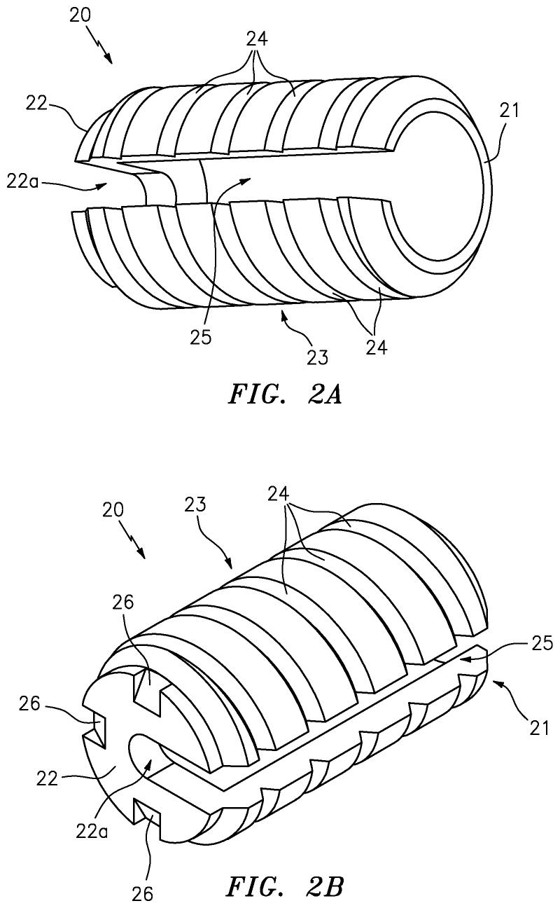

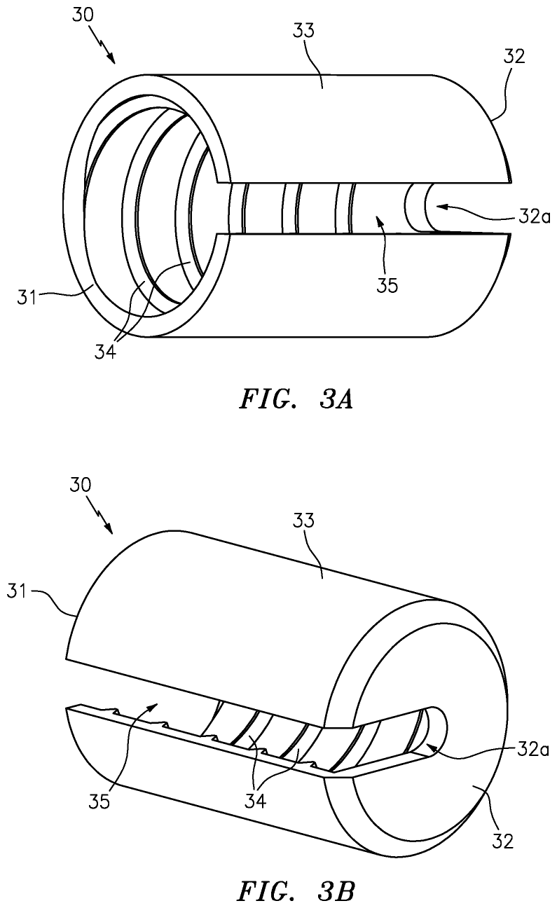

FIGS. 2A and 2B illustrate one embodiment of the first sleeve device 20. As shown, the device 20 can include an elongated generally tubular-shaped member having an open first end 21, a second end 22, a middle section 23 and a smooth hollow interior. A plurality of threaded elements 24 can be disposed angularly along the outside surface between the first and second ends. As will be described below, the threaded elements 24 can include a shape and size that are complementary to the shape and size of the receiver threads 34 that are positioned along the inside of second sleeve device 30. Threaded elements having lands and grooves for securing complementary shaped objects together via a twisting motion are extremely well known in the art and allow two such objects to be securely and removably connected via a twisting motion.

Although described herein as utilizing a plurality of embedded elements forming a screw thread along an outside portion of the first sleeve 20, and another plurality of embedded elements forming a receiving thread along an inside periphery of the second sleeve member 30, this is for illustrative purposes only, as any number of other devices capable of removably securing two portions of an in-line connector together in the manner described herein are also contemplated.

As shown best at FIG. 2B, the second end 22 of the first sleeve 20 can include a generally C-shaped member having a central opening 22a that extends perpendicular to the major axis of the sleeve and communicates with an elongated slit 25 that extends between the entirety of the first and second ends. Additionally, a plurality of indentations and/or protrusions 26 can be positioned along the outside facing surface of the second end 22. The indentations/protrusions functioning to provide an angled surface that can receive a rotational force from a tool or users finger, for example when the middle section 23 of the first sleeve is positioned completely inside the second sleeve 30.

As noted above, the system 10 is designed to be manufactured for use with different types/sizes of in-line connectors. As such, the cross-sectional dimensions of the first and second sleeves can vary based on the intended use. In either case, it is contemplated that the first sleeve can include an inside diameter that is slightly (e.g., between approximately 1% and 10%) larger than the cross sectional outside diameter of an in-line plug component for which the sleeve is designed to be used.

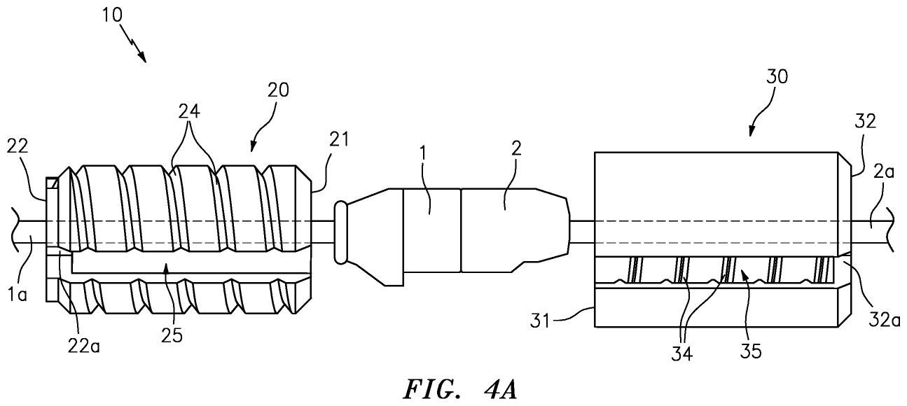

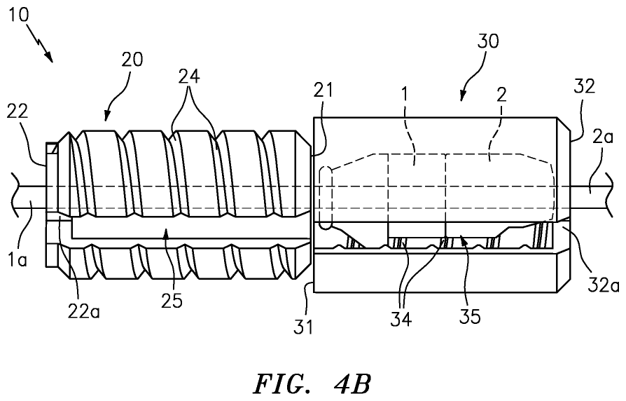

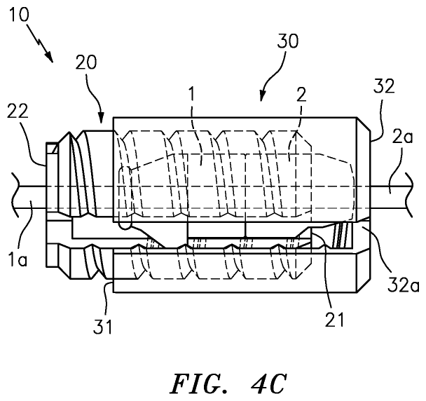

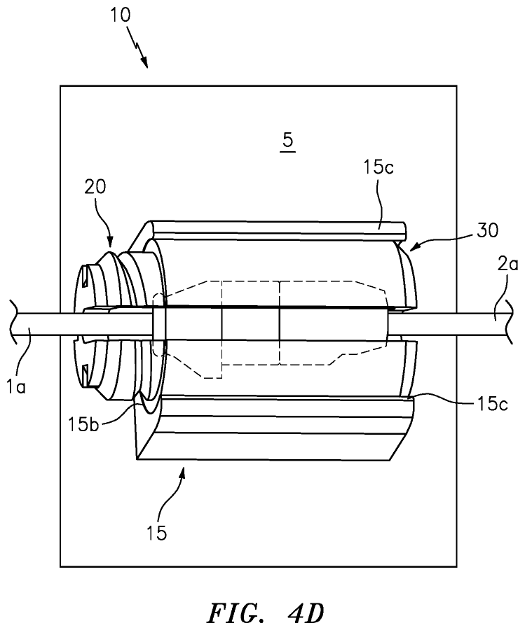

For example, when designed for use with a DC barrel connector having an outer dimension of 1 inch, the inside diameter of the first sleeve can be between 1.01 and 1.1 inches, so as to receive the same. Likewise, when designed for use with a 3-prong AC power cord (see FIG. 4) having an outer dimension of 3 cm, the inside diameter of the first sleeve can be between 3.03 and 3.3 inches, for example. Of course, any number of other dimensions are also contemplated.

As described herein, the first sleeve will preferably be constructed from a lightweight non-electrically conductive material such as plastic, for example, that is rigid or slightly resilient so as to be capable of expanding and reducing the width of the elongated slit. Of course, any number of different construction materials and properties are also contemplated.

FIGS. 3A and 3B illustrate one embodiment of the second sleeve 30. As shown, the device 30 can also include an elongated hollow generally tubular-shaped member having an open first end 31, a second end 32, and a middle section 33. A plurality of threaded elements 34 (i.e., receiver elements) can be disposed angularly along an entirety of the inside surface between the first and second ends.

Because the second sleeve 30 is designed to receive the first sleeve 20 through the first end 31, the sleeve 30 includes an inside diameter that is complementary to the outside diameter of the first sleeve. Moreover, the threaded elements 24 and 34 are positioned so as to align the lands and grooves of the threaded elements 24 with the grooves and lands of the receiver threads 34, respectively, so as to allow insertion of the first sleeve into the second sleeve via a twisting motion.

As shown best at FIG. 3B, the second end 32 of the second sleeve 30 can also include a generally C-shaped member having a central opening 32a that extends perpendicular to the major axis of the sleeve and communicates with an elongated slit 35 that extends between the entirety of the first and second ends.

As described herein, the second sleeve will preferably be constructed from a lightweight non-electrically conductive material such as plastic, for example, that is rigid or slightly resilient so as to be capable of expanding and reducing the width of the elongated slit. Of course, any number of different construction materials and properties are also contemplated.

FIGS. 4A-4C illustrate one embodiment of the system 10 in operation with a conventional in-line connector, such as the illustrated electrical plug 1 and socket 2. As shown, at FIG. 4A, the plug and socket can be connected in the expected manner and the respective cables 1a and 2a can be positioned through the elongated slits 25/35 and through the second ends 22a and 32a of the first and second sleeves 20 and 30, respectively. When so positioned, the first end 21 of the first sleeve 20 will be aligned with the first end 31 of the second sleeve 30.

As shown at FIG. 4B, the first and second sleeves can be moved together so as to encompass the plug and socket. When the first ends 21 and 31 meet, a user can impart a twisting motion onto one or both of the sleeves to cause the external threads 24 of the first sleeve to communicate with the internally located receiver threads 34 of the second sleeve. As the twisting motion continues, the first sleeve 20 will continue to move within the inside of the second sleeve until both the plug 1 and socket 2 are located within the inside of the first sleeve 20 shown at FIG. 4C.

Finally, as shown at FIG. 4D, the assembled sleeves 20 and 30 can be placed onto the curvilinear surface 15b of the mounting clip 15 that has been fastened to an object 5 such as a wall or desk, for example. When so positioned, the resilient arms 15c can engage the sleeve(s) thereby further immobilizing the assembly and preventing inadvertent separation of the plug and socket.

By securing the first and second sleeves together in a manner that is not affected by linear forces, (e.g., via a twisting motion), the system prevents inadvertent separation of the in-line connector via a pulling motion, and thus advantageously prevents damage to the same. Moreover, because the system 10 is constructed from plastic and owing to the tolerances of the threads 24/34 the system provides a barrier against brief exposure to liquids which could otherwise cause an electrical short.

Accordingly, the above described system provides a novel solution for locking the male and female components of an in-line connector together in a removable manner so as to prevent inadvertent separation and/or damage to the same.

As described herein, one or more elements of the system 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the terms “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. An in-line connector locking system, said system comprising:
a first sleeve member that includes an elongated hollow body having a first end, a second end, an inside diameter, and an outside diameter;
a second sleeve member that includes an elongated hollow body having a first end, a second end, an inside diameter, and an outside diameter;
wherein the inside diameter of the first sleeve member is complementary to an outside cross-sectional dimension of an in-line connector having both a male plug and a female socket, and the first sleeve member is configured to be removably secured to the second sleeve member.

2. The system of claim 1, further comprising:
a mounting clip that is configured to removably engage the first sleeve member, the second sleeve member and an external structure.

3. The system of claim 2, wherein the mounting clip comprises:
an elongated, generally U-shaped body having a flat bottom end, a curvilinear top end and a pair of resilient arms extending away from the top end.

4. The system of claim 3, wherein the curvilinear top end includes a cross sectional shape and dimension that is complementary to the cross-sectional shape and dimension of the second sleeve member.

5. The system of claim 4, wherein a separation distance between the pair of resilient arms is complementary to a width of the second sleeve member.

6. The system of claim 1, wherein the first sleeve member is configured to be removably secured within the elongated hollow body of the second sleeve member.

7. The system of claim 1, further comprising:
a first plurality of threaded elements that are positioned along the first sleeve member.

8. The system of claim 7, further comprising:
a second plurality of threaded elements that are positioned along the second sleeve member.

9. The system of claim 8, wherein the first plurality of threaded elements and the second plurality of threaded elements include complimentary dimensions and are configured to removably secure the first sleeve member within the second sleeve member via a twisting motion.

10. The system of claim 1, further comprising:
a first elongated slit that is positioned along the first sleeve member, said first elongated slit being configured to receive a cable from a male plug that is positioned within the first sleeve member.

11. The system of claim 10, further comprising:
a second elongated slit that is positioned along the second sleeve member, said second elongated slit being configured to receive a cable from a female socket that is positioned within the second sleeve member.
